(19) United States
(12) Patent Application Publication
(10) Pub. No.: US 2003/0185455 A1
(43) Pub. Date: Oct. 2, 2003

(54) Digital image processor

(76) Inventor: Kenbe D. Goertzen, Topeka, KS (US)

Correspondence Address: BROMBERG & SUNSTEIN LLP, 125 SUMMER STREET, BOSTON, MA, 02110-1618, US

(21) Appl. No.: 10/352,375

(22) Filed: Jan. 27, 2003

Related U.S. Application Data
(63) Continuation-in-part of application No. 09/498,924, filed on Feb. 4, 2000, now Pat. No. 6,532,308.
(60) Provisional application No. 60/351,463, filed on Jan. 25, 2002.
(60) Provisional application No. 60/356,388, filed on Feb. 12, 2002.
(60) Provisional application No. 60/118,554, filed on Feb. 4, 1999.

(51) Int. Cl. G06K 9/36

(52) U.S. Cl. 382/240

(57) ABSTRACT

An electronic chip for processing a digital image stream having digital data values representing pixels and resulting digital signal. The electronic chip includes a compression module for compressing the digital image stream so that upon decompression the digital image stream maintains a pre-determined signal to noise ratio for each digital data value. The compression module may compress the digital image stream such that digital data values are quantized so as to maintain a desired resolution over all frequencies. The electronic chip may further include a digital image input port for receiving the digital image stream and a digital data output port for outputting the digital data stream formatted as a digital data packet.

### CROSS REFERENCE TO RELATED APPLICATIONS

The following application claims priority from U.S. Provisional Patent Application No. 60/351,463 filed on Jan. 25, 2002 entitled Digital Mastering Codec ASIC and bearing attorney docket no. 2418/130, the application also claims priority from U.S. Provisional Patent Application No. 60/356,388, entitled Codec filed on Feb. 12, 2002 bearing attorney docket no. 2418/131, and from U S. patent application Ser. No. 09/498,924 filed on Feb. 4, 2000 entitled Quality Priority Image Storage and Communication which itself has a priority claim to U.S. Provisional Patent Application No. 60/118,554 entitled Quality Priority Image Storage and Communication all of which are incorporated by reference herein in their entirety.

### TECHNICAL FIELD AND BACKGROUND ART

The present invention relates to electronic circuits and more specifically to electronic circuits for image processing and compression.

It is known in the prior art to compress digital image data. Further, it is known in the prior art to make digital image compression electronic chips. For example, there are multiple MPEG-based chips that are produced that perform MPEG based compression for such applications as DVD compression. Such MPEG based chips compress a digital image stream employing transform encoding, quantization and entropy encoding. The transform based encoding of these electronic chips is normally a form of the discrete cosine transform (DCT). The DCT provides for correlation of data based upon the stationarity of the digital image. Stationarity implies that the image has either little or no change over the given processed region. For example, an image, of the sky provides high stationarity since from point to point within the image there is little change. Since stationarity is required, the image size that is selected for DCT based transforms to maximize the correlation is a segment of an image. Normally the segment is a block of approximately 16×16 pixels or 64×64 pixels. These blocks represent only a small percentage of an overall image frame in order to preserve stationarity. Because the image is subdivided during the transform coding step, the image when it is decompressed by a decoding electronic chip exhibits block artifacts since each block is compressed individually. Thus, correlation between blocks within the image is not accounted for. Since this correlation is not accounted for and each block is transform encoded and compressed based upon the individual frequencies within the block the compression scheme cannot have a guaranteed resolution over all frequencies within the image. Thus, it would be desirable to have an electronic chip that could produce a digital data stream have a predetermined format that once decompressed would have a desired resolution over component values.

### SUMMARY OF THE INVENTION

In one embodiment the invention is an electronic chip for processing a digital image stream having digital data values representing pixels. The electronic chip includes a compression module for compressing the digital image stream so that upon decompression the digital image stream maintains a pre-determined signal to noise ratio for each digital data value. The compression module may compress the digital image stream such that digital data values are quantized so as to maintain a desired resolution over all frequencies. The electronic chip may further include a digital image input port for receiving the digital image stream and a digital data output port for outputting the digital data stream formatted as a digital data packet. In other embodiments the electronic chip may further include an interlaced module for converting a digital image stream from an interlaced format to a progressive format. The interlace processor may also decorrelate both spatially and temporally each pair of fields representing a frame. The electronic chip may also include an encryption module for encrypting the digital image stream.

In certain embodiments of the invention, the compression module is configured to perform wavelet-based transforms. The compression module also includes a spatial transform module. The spatial transform module is capable of employing a wavelet transform to decorrelate each image within the digital image stream into a plurality of frequency bands. The compression module may also include a temporal transform module capable performing a temporal decorrelation using a wavelet transform on the digital image stream to transform the digital image stream into a plurality of frequency bands. The compression module further includes a quantization module. The quantization module assigns a quantization level to each defined frequency band according to sampling theory. The quantization module also has circuitry for quantizing each transformed digital data value so that each transformed digital data value has the proper resolution for maintaining a desired quality level over all digital data values in the digital image stream. The quantization module includes circuitry for assigning quantization levels with greater accuracy to each frequency band of lower frequency.

To provide compression the compression module includes an entropy encoder. The entropy encoder includes circuitry for selecting a probability distribution function based upon a characteristic of the digital image stream. After a probability distribution function is selected, a probability is determined for a current value from the digital image stream. Once a probability is determined, Huffman encoding nay be employed.

In an alternative embodiment, the electronic chip has a digital data output port that contains circuitry for adding a header to the digital data packet, wherein the header at least indicates size. In some embodiments the size header indicates the size of original digital data stream and in other embodiments it indicates the size of the data internally processed within the electronic chip. The electronic chip may perform compression in a real-time manner on streaming media.

The output of the electronic circuit is in the form of a data packet including a header or just a digital data stream. The digital data packet may contain encrypted data or the data may be entropy encoded. The data packet may also contain block boundary information. Further the data packet may have header information from the entropy encoder module including entropy encoding parameters. The parameters may include signal to nosie ratio, core magnitude, dither magnitude and dither seed.

In another embodiment the invention includes the resultant digital data. The digital data may be on a carrier wave or the digital data may be on a medium readable by a processor. The digital data includes compressed digital data that upon decompression maintains at least a pre-determined signal to noise ratio over all digital data values. The digital data may also include an appended header. The digital data is encoded such that a known resolution is maintained over all frequencies wherein during quantization bits of resolution are assigned such that lower frequencies are assigned more bits of resolution. The digital data may include a header and the header may indicate size of the data. Further, the header may indicate size of compressed or encrypted data. The digital data that is compressed may be encrypted and or entropy encoded. Within the digital data there may be additional information such as signal to noise ratio/quality level/resolution, dither seed etc.

### BRIEF DESCRIPTION OF THE DRAWINGS

The foregoing features of the invention will be more readily understood by reference to the following detailed description, taken with reference to the accompanying drawings, in which:

FIG. 1 is a block diagram that shows the input and output streams from an electronic circuit for compression of digital images;

FIG. 1A is block diagram showing one embodiment of the electronic circuit for compressing a digital image stream such that a signal to noise ratio is maintained for all digital data values in the uncompressed digital image stream;

FIG. 2 shows an embodiment of the image I/O port. FIG. 3 is a block diagram showing the quantizer of the entropy encoding module;

FIG. 3A is a block diagram showing a circuit within the entropy encoder for the lowest frequency band;

FIG. 3B is a block diagram showing the inside of the entropy encoder;

FIG. 3C is a table that shows a look-up table used for entropy encoding;

FIG. 3D is the output stream data format from the entropy encoder module;

FIG. 4 is a block diagram showing the encryption module;

FIG. 4A is the output stream data format from the encryption module;

FIG. 5 is a block diagram showing the data I/O port;

FIG. 6 is the output stream data format from the data I/O port.

FIG. 6A is the data format that exits the data I/O port if neither entropy encoding or encryption has occurred to the digital image stream;

FIG. 6B is the data format that exits the data I/O port if the digital image stream is entropy encoded;

FIG. 6C is the data format that exits the data 10 port if the digital image stream is only encrypted;

FIG. 6D is the data format that exits the data I/O port if the digital image stream undergoes both entropy encoding and encryption;

FIG. 7 is a block diagram showing the global control module communicating with the other modules;

FIG. 8 is an interlace module block diagram;

FIG. 9 is a diagram showing the interlace process determining an error function;

FIG. 10 is a diagram showing the interlace process wherein the data for two fields forming a frame are processed with a filter;

FIG. 10A is a diagram representing a first embodiment for interlace filtering;

FIG. 10B is a diagram representing an alternative embodiment for interlace filtering;

FIG. 10C is an example of a filter that is used for determining the high frequency component in the interlace processing module according to the technique of FIG. 10B;

FIG. 10D is an example of a filter that is used for determining the low frequency component in the interlace processing module according to the technique of FIG. 10B;

FIG. 111 is a block diagram of the temporal transform module;

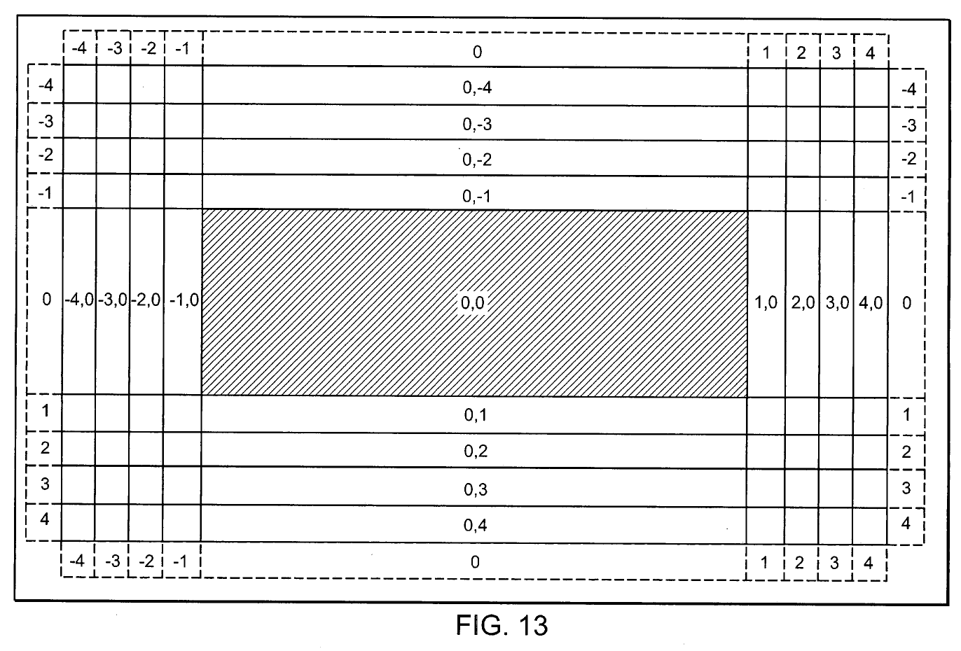

FIG. 12 is a block diagram of the spatial transform module; and

FIG. 13 is a diagram showing the various sequences in which the filter may be over invalid data and therefore mirroring should occur.

### DETAILED DESCRIPTION OF SPECIFIC EMBODIMENTS

Definitions. As used in this description and the accompanying claims, the following terms shall have the meanings indicated, unless the context otherwise requires: the term digital image stream refers to a raw data stream which may include color components, for example R,G,B or Y,U,V.

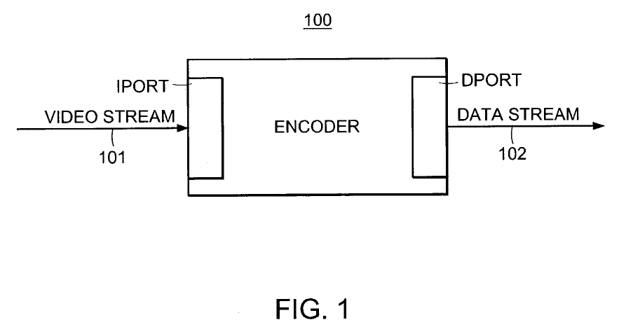

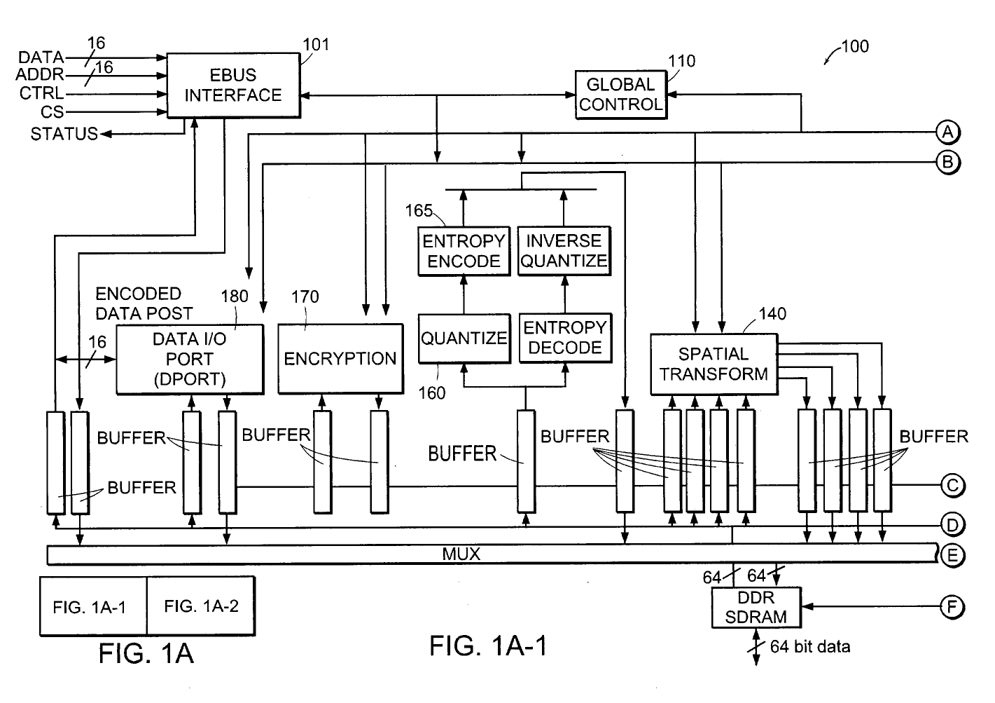

FIG. 1 is a block diagram that shows the input and output streams from an electronic circuit 100 for compression and decompression of digital data. Preferably the electronic circuit 100 is an application specific integrated circuit (ASIC). The electronic circuit 100 receives at its input a digital data stream and preferably a digital image stream 101. The digital image stream 101 is composed of raw video image data. The digital image stream 101 has a predetermined video format, including component location for each frame of video having a vertical size and a horizontal size. The electronic circuit 100 transforms the digital image stream 101 into a data stream 102 which is output from the electronic circuit. The electronic circuit may encrypt the digital image stream 1101 and/or compress the digital image stream 101. The encoded digital image stream may be spatial and/or temporally transform encoded, quantized and entropy encoded. The electronic circuit 100 may also decorrelate the digital image stream to account for interlacing.

Within the electronic circuit are seven modules that process the digital image stream. In the preferred embodiment, each of the modules is incorporated into a single ASIC. The seven modules include an image I/O port, an interlace processing module, a temporal transform module, a spatial transform module, an entropy encoder/quantizer module, an encryption module, and a data I/O port. Each module may be used alone or in combination in the processing of the digital image stream. Each module is programmable and operates in conjunction with a programming language such as a thread processing language (TPL) as is known in the art, wherein the program is read into the modules by an external CPU. The program that is sent to the modules can be for encoding or decoding such that the same electronic circuit can be used for encoding and decoding of a digital image stream. The modules are synchronized through a global control module which maintains a set of registers that each module can read from and write to. Further, each module can pass data onto a common communication bus that is coupled to each of the modules and is in communication with memory.

The output format of the electronic circuit upon encoding is in one of two forms. Either the digital image stream is transformed into a pure digital data stream or the digital data stream includes a header block with a size parameter which indicates the size of the data. Each module within the electronic circuit may operate on the digital image stream or selected modules may operate on the stream. For example, the digital image stream maybe simply encrypted wherein only the encryption module would operate on the digital image stream or the digital image stream may undergo processing in the spatial transform module and the quantization/entropy encoder module only prior to being output by the digital data I/O port. In this electronic chip, the interlace module, the image I/O port, the spatial transform module and the temporal transform module do not produce an output with header information. Only the entropy encoder/quantizer module, the encryption module and the data I/O port produce header information. This header information is passed between modules and the header information from the entropy encoder/quantizer module and the encryption module are incorporated into the digital data stream. The data I/O port appends the output header size information and all other header information that is internal to the electronic chip is either stripped away or subsumed within the digital data of the digital data stream. For example, if there is header information already present that includes size informations and has a block boundary, the output would include the size header, followed by any other header information and then the digital data stream, wherein the block boundary would be removed.

FIG. 1A is a block diagram that shown in more detail the electronic circuit of FIG. 1. The electronic circuit 100 includes a global control module 110 that provides for synchronization of the digital image stream 101 between each of the modules via the communication bus. The global control module 110 receives input commands and outputs information to an external central processing unit (CPU) (not shown) and also communicates the digital data stream 101 to external memory (not shown).

The image I/O port 120 receives in the digital image stream 101 from an external source. The image I/O port 120 accepts various image formats such as monochrome, RGB, YUV etc. and supports interlaced and progressive based data.

The interlace processing module 130 performs vertical filtering such as that discussed in U.S. patent application Ser. No. 10/139,532 which is incorporated by reference herein in its entirety. The vertical filtering decorrelates data between two fields within the digital image stream. The filtering provides for the separation of frequency components within the two fields that make up a frame of video. After the digital data within the digital data stream that represents the two fields of data are decorrelated, the frequency divided data set can then be processed as if the data is for a video frame. The interlace processor may also provide image filtering and color modulation.

The spatial transform module 140 provides for two dimensional filtering of the digital image stream and preferably performs a wavelet based transform wherein the transform creates a frequency partitioned representation of the digital image stream. The temporal transform module 150 spatially decorrelates data from multiple images such that the images are temporally decorrelated. As with the spatial transform module, the temporal transform module preferably performs a wavelet based transform.

In preferred embodiments, the spatial and the temporal modules 140, 150 are accessed in sequential fashion in order to provide for optimal decorrelation and compression.

The quantizer/entropy encoder provides entropy encoding according to U.S. Pat. No. 6,298,160 which is incorporated herein by reference in its entirety. The entropy encoder module 165 uses recent values in the digital image stream to determine a value that represents a characteristic of the stream. In one embodiment, a weighted average of the most recent digital image stream values is determined and this weighted average is used to select a probability distribution function from a look-up table which associates the weighted average with a properly shaped probability distribution function based upon the characteristic of the digital image stream. This probability distribution function is then used in combination with the most recent digital image stream value to determine a probability for that value. Based upon the probability that is determined the entropy encoder encodes the value using Huffman encoding. The quantizer module 160 which precedes the entropy encoder 165 upon encoding and which occurs after entropy decoding upon decoding, quantizes the values within the digital image stream according to a sampling theory curve and a selected resolution. Based upon a resolution that is either selected by a user of the electronic circuit or that is predetermined, a set of quantization levels is determined based upon a sampling theory curve for the selected resolution. The resolution that is selected is for the signal to noise ratio at the Nyquist frequency. Based upon sampling theory, for every octave decrease the necessary resolution increases by 3 dB or ½ bit for every dimension in order to preserve the same signal to noise ratio as at the Nyquist frequency for all sample values. As a result, data from the digital image stream 101 that come from lower frequency bands are quantized with more bits so as to maintain the desired resolution. For example, if the digital image stream 101 is split into three frequency bands (low, med, and high) and the desired resolution is 12 bits at Nyquist, the lowest frequency within the high band is determined and if it is within the first octave below Nyquist, the band is quantized with 12 bits. If the med frequency band falls within the second octave below Nyquist, this band will be quantized with 13 bits of information (assuming that there is only spatial encoding of the image of two dimensions). If the lowest frequency band falls within five octaves below Nyquist, the band will be quantized with 16 bits.

The combination of the spatial transform module 140, the temporal transform module 150 and the quantizer 160 implement an encoding mechanism that is referred to hereinafter as quality priority encoding. Employing quality priority encoding, a predetermined resolution is maintained over samples within the image data stream upon decompression of the digital data. Quality priority encoding along with the spatial transform module, the temporal transform module and the quantizer are further explained in concurrently filed U.S. patent application which is entitled “Quality Priority Encoding” and which bears attorney docket no. 2418/137 all of which is incorporated herein by reference in its entirety.

The encryption module 170 encrypts the digital image stream using the advanced encryption standard (AES) and also employs a large integer exponentiator that enables public key infrastructure (PKI) distribution of security keys. The data I/O port 180 couples to external devices or circuitry and outputs the encrypted and compressed data stream translating the digital data stream between the internal clock of the electronic circuit and the external clock.

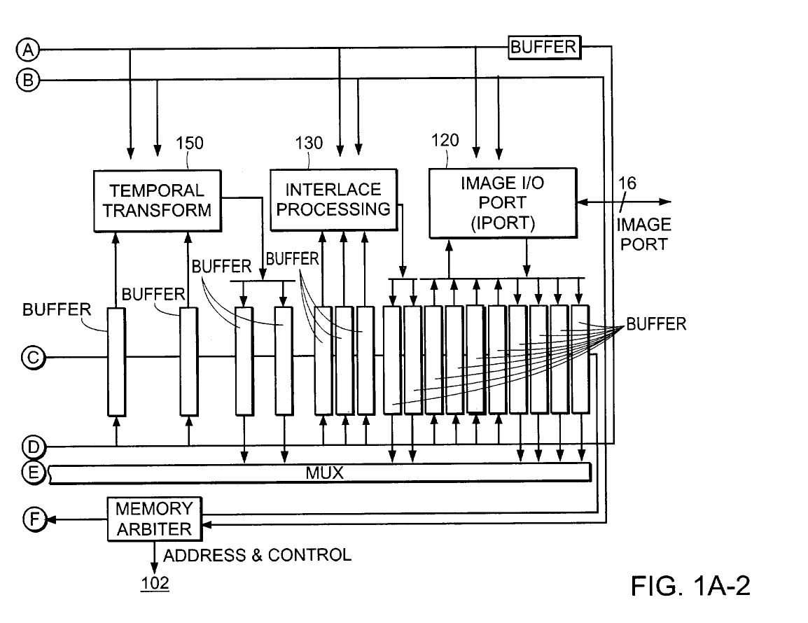

FIG. 2 shows an embodiment of the image I/O port 120: The image I/O port 120 may be configured as either an input or an output with appropriate handshaking for data exchange with extern interfaces. The I/O port 120 has four input and output buffers 210, 215 to support four input or output streams so as to facilitate the manipulation of four component video image streams. Although there are only four inputs, the I/O port 120 may process a digital image stream having multiple color components in excess of four, such as, Earth Resources data which has 36 components. In such an embodiment, a wavelet transform is performed on the color components to decorrelate the color information. The wavelet transform can be recursively performed on the digital image stream. For example, a single pixel which has 36 components could be passed through a wavelet filter and recursively filtered in a pyramid scheme. In such an embodiment the data would be horizontally filtered and the lowest frequency of the transformed data set would represent the luminance of the pixel. In the process of decorrelating the data, the amount of data that was non-zero in value would be greatly reduced, allowing the electronic circuit to process images having a very high bandwidth. The image I/O port 120 provides for the conversion of unsigned data into two's compliment format for internal processing and back to unsigned format for output in the unsigned to 2's comp module 220 and 2's comp to unsigned module 225. A pseudo random dither function in a dither module 230 allows inputs and outputs to be dithered on a component-by-component basis. The interface 120 is synchronous with an externally provided clock. The image stream data 101 is synchronized: to the electronic circuit's internal system clock through rate change buffers 240, 245. The image port controller 250 controls the direction of the data and sends protocol signals for controlling the rate change buffers 240, 245 and the input and output buffers 210, 215.

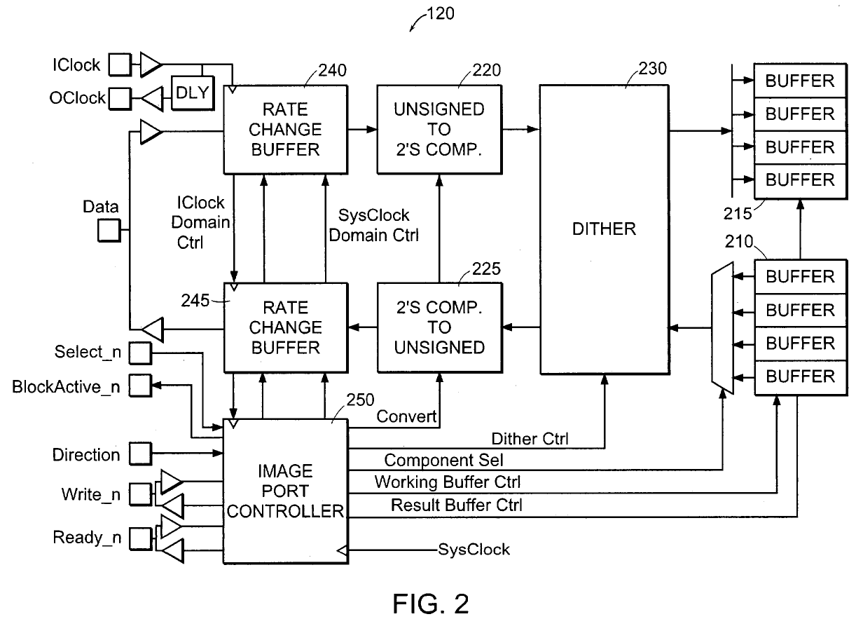

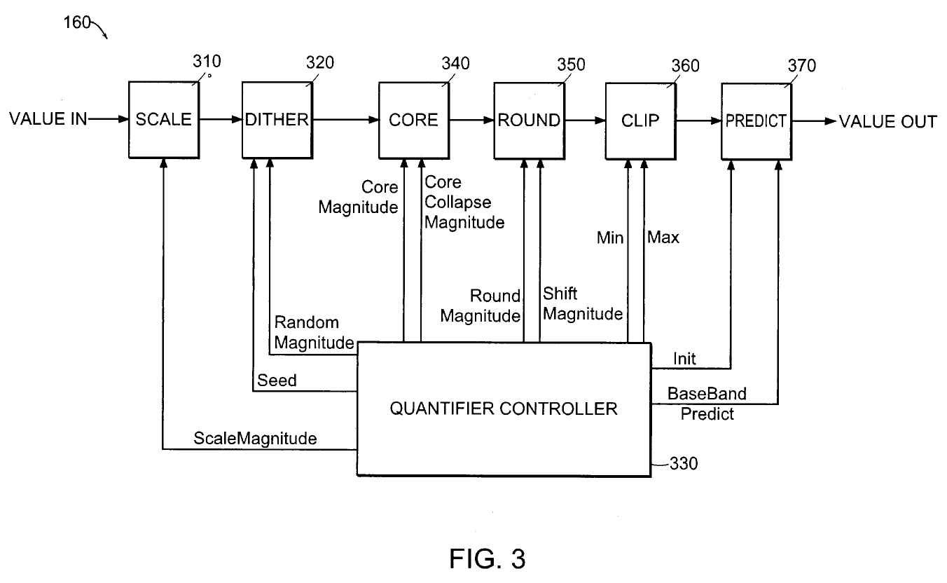

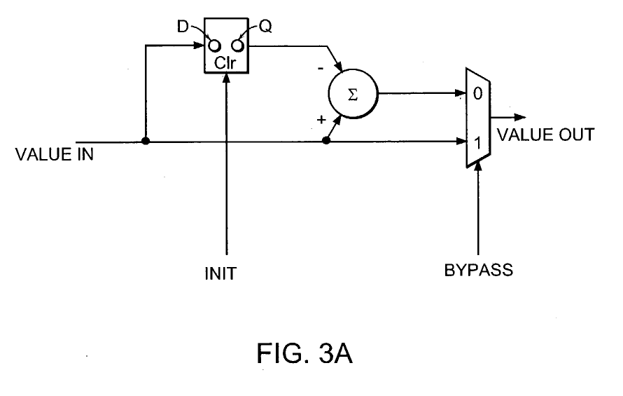

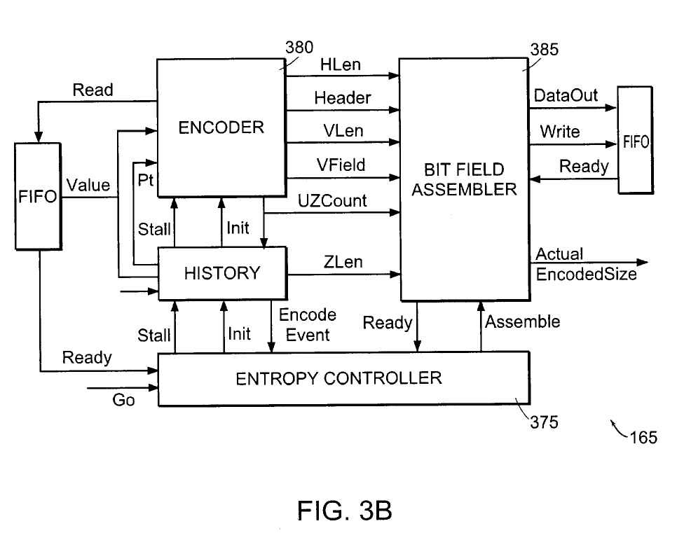

During encoding the quantization process occurs before entropy encoding and thus the quantizer will be explained first as shown in FIG. 3 The quantification process is performed in the following manner. A value is passed into the quantizer 160. The quantizer 160, may be configured in many different ways such that one or more of the following modules is bypassed. The description of the quantizer should in no way limit the scope of the claimed invention.

The value is first scaled in a scaling module 310. In one embodiment, the scale function of the scaling module 310′ multiples the value by a scale magnitude. This scale magnitude allows for the electronic circuit to operate at full precision and reduces the input value to the required signal to noise ratio (Resolution). Each value that enters the quantizer is assumed to have passed through either the spatial or the temporal transform modules. As such, the image is broken up into various frequency bands. The frequency bands that are closer to DC are quantized with more bits of information so that values that enter the scaling module that are from a frequency band that is close to DC, as opposed to a high frequency band, are quantized with more bits of information. Each value that is scaled will be scaled such that the value has the appropriate quantization, but also is of a fixed length. The scaled value is then dithered. A seed value and a random magnitude are passed to the dither module 320 from the quantifier controller 330. The dithered value is linearized for quantification purposes as is known in the art. The signal is then sent to a core block 340. The core block 340 employs a coring magnitude value as a threshold which is compared to the scaled value and which forces scaled values that are near zero to zero. The coring magnitude 340 is passed to the core block 340 from the quantifier controller 330. If a field value called collapsing core magnitude is passed, this value represents a threshold for setting values to zero, but is also subtracted from the values that are not equal to zero. The system may also bypass the coring function and pass the scaled value through. The scaled data value is passed to a rounding module 350 where values may be rounded up or down. The data is then passed to a clip module 360. The clip module 360 receives a max and min value from the quantifier controller 330. The clip module 360 then forces values to the max value that are above the min. value. The signal is then sent to a predict block 370. The baseband prediction module 370 is a special case quantizer process for the data that is in the last band of the spatial transform output (values closest to DC frequency). The baseband predictor “whitens” the low frequency values in the last band using the circuit shown in FIG. 3A

The entropy encoder module 165 is shown in FIG. 3B. The entropy encoder module 165 is a loss-less encoder which encodes fixed-bit words length image data into a set of variable-bit width symbols. The encoder assigns the most frequently occurring data values minimal bit length symbols while less-likely occurring values are assigned increasing bit-length symbols. Since spatial encoding, which is Wavelet encoding in the preferred implementation, and the quantification module tend to produce large runs of zero values, the entropy encoder takes advantage of this situation by run-length encoding the values into a single compact representation. The entropy encoder includes three major data processing blocks: a history/preprocessor 375, encoder 380, and bit field assembler 385. Data in the history block 375 is in an unencoded state while data in the encoder 380 and bit field assembler 385 is encoded data. The encoder 380 performs the actual entropy based encoding of the data into variable bit-length symbols.

The history/preprocessor block 375 stores recent values. For example, the history block may store the four previous values, or the six previous values and the history block may store N previous values. The values are then average weighted and this value is passed to the encoder module 380 along with the most recent value. The encoder module 380 then selects a probability distribution function by accessing a look-up tabled based upon the weighted average. The most recent value is then inserted into the probability distribution function to determine a probability. Once a probability is determined, a variable-length value is associated with the probability by accessing a look-up table. The bit field assembler 380 receives the variable length data words and combines the variable length data words and appends header information.

The header may be identified by subsequent modules, since the header is in a specific format. For example, the sequence may be a set number of 1 values followed by a zero value to indicate the start of the header. The header length is determined by the length of the quantized values which is in turn dependent on the probability of the data word. The header length in conjunction with a length table determines the number of bits to be allocated to the value field. An example of such a look-up table is shown in FIG. 3C.

The unencoded zero count field contains a value representing the number of zeros that should be inserted into the data stream. The number of zero values is determined in the history module 375 and flagged and passed to the encoder module 380. This field may or may not be present and depends on the image data stream that is provided from the quantizer. If there is a predetermined number of zero values that follow a value in the data stream, the zero values can be compressed and expressed as a single value which represents the number of zero values that are present consecutively. As was previously stated, both the quantizer module and the spatial and temporal encoder module will cause the transformed digital image stream to have long stretches of zero values. As such, when multiple zeros are observed within the digital image stream, an unencoded zero count field is added. The encoder 380 performs this function prior to passing the information to the bit field assembler 385.

The bit field assembler 385 waits for the header, value field and unencoded zero count field before outputting any data. The bit field assembler 385 has a buffer for storing the maximum size of all three fields. The bit field assembler assembles the data into the output format for the entropy encoder. The format is explained below with respect to FIG. 3D FIG. 3D is the output stream data format from the entropy encoding module. The entropy encoding module produces entropy encoded data and an entropy encoded header is appended 300A. This header is a global header that has a programmable size. In one embodiment the size of the header varies between 0 and 32 words wherein a word is 16 bits in length. Different parameters may be present in this global header 300A. For example, signal to noise ratio, core magnitude, dither magnitude and dither seed may be present. In this context, signal to noise ratio is the ratio of the signal power versus the noise power that is desired for all samples of the original digital image sequence. The signal to noise ratio is a pre-determined settable value which allows a user of the system to set the quality level of the digital image stream upon decompression. The dither magnitude parameter is used to control the amplitude of the random dither that is used to generate image texture and to linearize the quantization function. The dither seed is the number used to feed a random number generator to generate the dither value. Each block could also contain a local header block 310A which may be used to define a local quantization parameter for the data block. For example, when quality priority encoding occurs, the electronic circuit identifies the desired S/N ratio and determines the number of transformations that may be performed based upon a know 6 dB loss per transform dimension. Based upon the number of known transforms that will occur and therefore the number of frequency divisions for the image signal, different quantization levels are assigned each of the frequency divisions. As such, a single image/frame may have multiple frequency divisions, each of which is to be quantized at a different scale. Because there may be a different scale for each block there can be a different S/N ratio assigned for that block. Further explanation of quality priority encoded can be found in co-pending U.S. patent application Ser. No. ______ filed concurrently with the present application entitled “Quality Priority” bearing attorney docket number 2418/128. The local header 310A differs from the global header 300A in the fact that it is entropy encoded. To clarify, the local header provides additional information about the quantization parameters for a given block, whereas the global header 300A provides the default parameters. Each parameter is necessary for accurately decompressing the digital data stream back into a digital image stream. One or more of the parameters may be eliminated, however the quality level of the compression system is reduced. In addition a size parameter is provided which indicates the overall size of the output global header, the local header and the entropy encoded data. Since this format is kept within the electronic circuit the output of the entropy encoder module includes a block boundary which in one embodiment is a series of zero transmitted signals. For example, the size header is transmitted, followed by 30 zeros, and then followed by the entropy encoded data including the local and global headers. FIG. 3D does not show the size header or the block boundary.

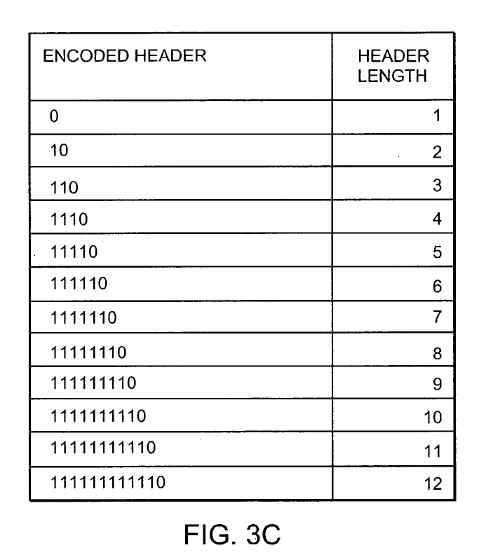

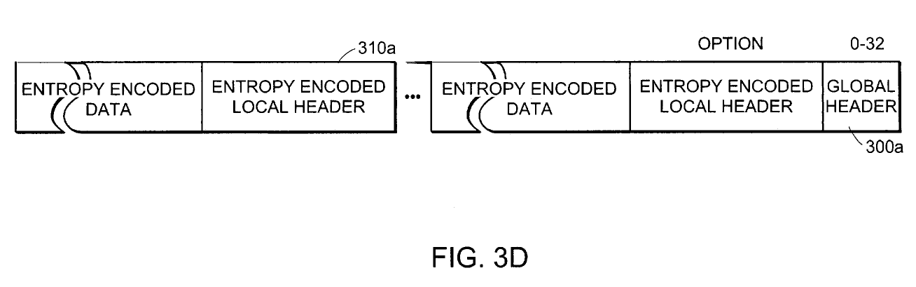

FIG. 4 is a block diagram showing the encryption module 170 that receives the digital video image stream as input through the input buffer 401. The crypto process combines a symmetrical block cipher along with a public key infrastructure (PKI) cipher for secure distribution of image decoding keys and is centered around an EEPROM structure 420. An example of a block cipher is the Advanced Encryption Standard (AES). The EEPROM structure 420 holds RSA private keys and the RSA signature of the PKI cipher. When a request is made for encryption or decryption by the CPU (not shown) that is controlling and electrically coupled to the encryption module through the crypto controller 430 to the EEPROM 420, the stored RSA private key is passed to the exponentiator engine 425 which yields enciphered or validated messages in the cipher out RAM 435. Since the RSA engine can be used as a general purpose cipher, it is necessary for the contents of the cipher out RAM 435 to be written to memory associated with the CPU via the result buffer 402 so that the CPU can read the results. It should be understood by one of ordinary skill in the art that each module is an independent processor which may receive processor program instructions such that the module may be used for many different purposes. For example the AES and PKI encryption may be programmed to work in tandem or only the PKI block may be activated. This is also true for each of the other modules within the electronic circuit. For example, the electronic circuit could be programmed such that only spatial encoding in the spatial transforms modules.

The encryption module is configured such that the CPU cannot read the cipher out RAM 435 under certain conditions. For example, the ability to read the cipher out RAM is restricted so that AES key codebooks are not readable by the external CPU and the AES key codebooks in the cipher out RAM 435 cannot be re-circulated to the cipher in RAM 434 and re-ciphered with another system 's public key. By preventing recirculation and by preventing the reading of the AES code book by the external CPU the encryption module maintains security.

The AES block 450 provides symmetrical cipher/decipher function on data from the crypto input buffer and writes result to the crypto result buffer 402. The key for the AES block 450 may be applied by either a write from an external CPU (not shown) through the input buffer 401 or from the cipher out RAM 435 into the AES key register 448. In such embodiments, the AES encryption encrypts the RSA encrypted key.

The encryption module performs both enciphering and deciphering of encrypted data. As such, the contents of the cipher out ram may be deciphered data or enciphered data employing the EEPROM RSA key or validated messages deciphered with the sender's public key. The cipher out ram may also have deciphered or enciphered AES packets. For example, if a movie is being deciphered which has already undergone AES deciphering, the deciphering occurs with the RSA movie key from the EEPROM. If the digital image stream which has already been enciphered with AES key packets, the packets are further enciphered with the recipient's public key.

The crypto controller 430 is responsible for restricting/enabling the flow of data between resources within the crypto module 170 based on the state of EEPROM fields and fields contained within the codebook packets of the cipher memories/buffers. The crypto controller 430 identifies states of data fields. For example, the codebook has a field that indicates if the data packet contains AES keys or general purpose messages. There is a field within the EEPROM 420 which when set blocks the sending of RSA keys. There is a recirculate field within the codebook packets that indicates if the packet may be re-circulated back to the cipher in ram.

As previously stated the EEPROM 420 holds the keys for exponentiation. Although the EEPROM is a non-volatile read/write device, the EEPROM will appear as a ROM when employed. After data has been put into the EEPROM 420, the EEPROM is locked by disabling the write function. The locked EEPROM 420 may not be written nor read by any device external to the electronic circuit and once in locked mode, the crypto controller 430 may only read from the EEPROM. It should be understood, that the digital data stream only passes between the input buffer 401, the AES module 450 and the output buffer 402.

FIG. 4A is the output stream data format from the encryption module. The encryption module appends the header data in the AES module. If the entropy encoder module is used prior to the encryption module, the encryption payload 400A will be an encrypted global header, local header and entropy encoded data. If the entropy encoder module is not used, the output of the encryption module will be encrypted image data. The Encryption module can accept data with or without a header

Appended to the crypto payload 400A is a side header 410A and a block boundary 420A. For example, the size header is a predetermined length, such as two word lengths, which is followed by the block boundary. As above, the block boundary may be any delimiter, such as, a series of zero values. The delimiter is recognized by the global controller for the electronic circuit. The block boundary 420A is followed by the crypto payload 400A. In another embodiment, there are two size headers, header 1 410A and header 2 420B. The first size header 410A one represents the size of the crypto payload plus the size of header 2 410B and the block boundary. Header 2 represents the size of the original unencrypted data.

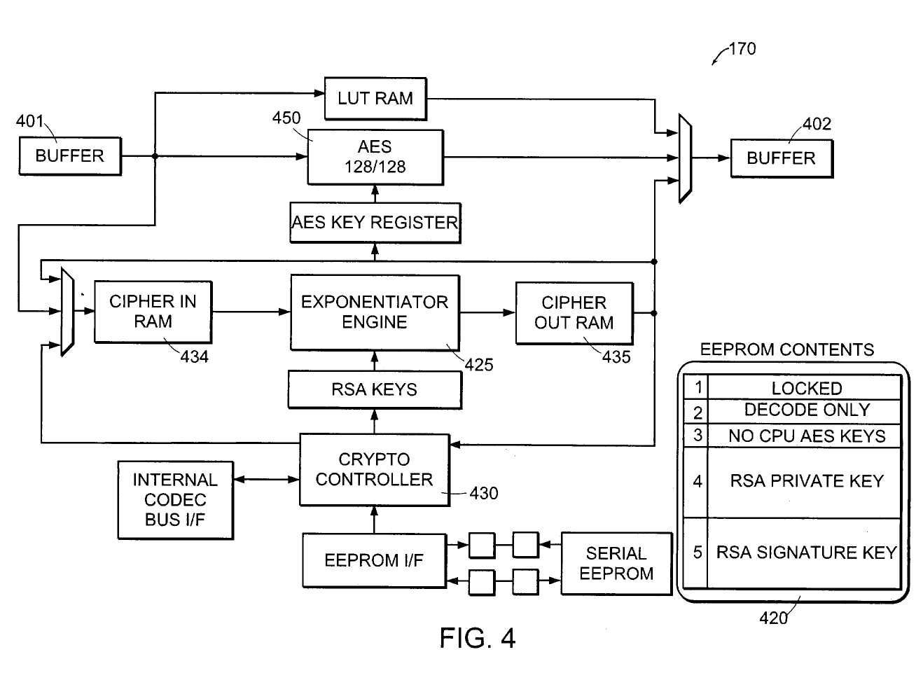

FIG. 5 is a block diagram showing the data I/O port 180. The data I/O port 180 is a bi-directional port for reading and writing encoded data to and from the various modules of the electronic circuit and to and from external devices or memory. The data I/O port 180 is synchronously timed to any external device that is coupled to the port and therefore is clocked asynchronously with respect to the rest of the electronic circuit. One of the main functions of the data I/O port 180 is rate change. The data I/O port 180 includes a rate change buffer 500 that is a FIFO that manages the transfer of data between the external device and the internal modules of the electronic circuit (ASIC). The data I/O port 180 is connected to a working buffer 501 and a result buffer 502 for this purpose. When the port is encoding data, the rate change buffer 500 passes data from the working buffer 501 to the output. When the port is in decode mode such that data flows from the port to associated memory, the rate change buffer 500 passes data from the input to the port result buffer 502. The Dport controller 520 performs a timing synchronization between the external and the internal clock such that data is stored in the appropriate buffer until the appropriate clock signal. Data is passed between rate change buffers 500 on appropriate clock cycles so that data at the input clock rate is written into a buffer and read from the buffer at the clock rate that is internal to the electronic circuit. The rate change buffer 500 operates as known by those of ordinary skill in the art.

The entropy encoder module, the encryption module and the data I/O port all support in-stream passing of size information between processes. The data I/O port can accept data that has header information or is without header information. For example non-entropy encoded streams will have no headers and the data I/O port will use a predefined programming call, such as a size call in the thread processing language, to ascertain the size of the number of samples to process. If the size header is present, the size header is used for determining the number of samples for processing.

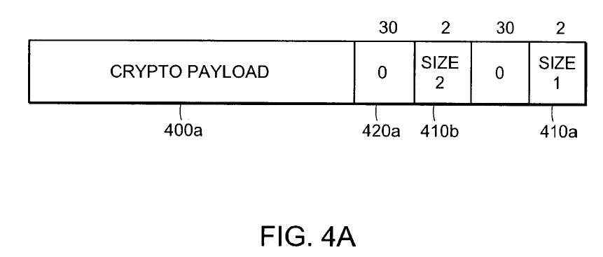

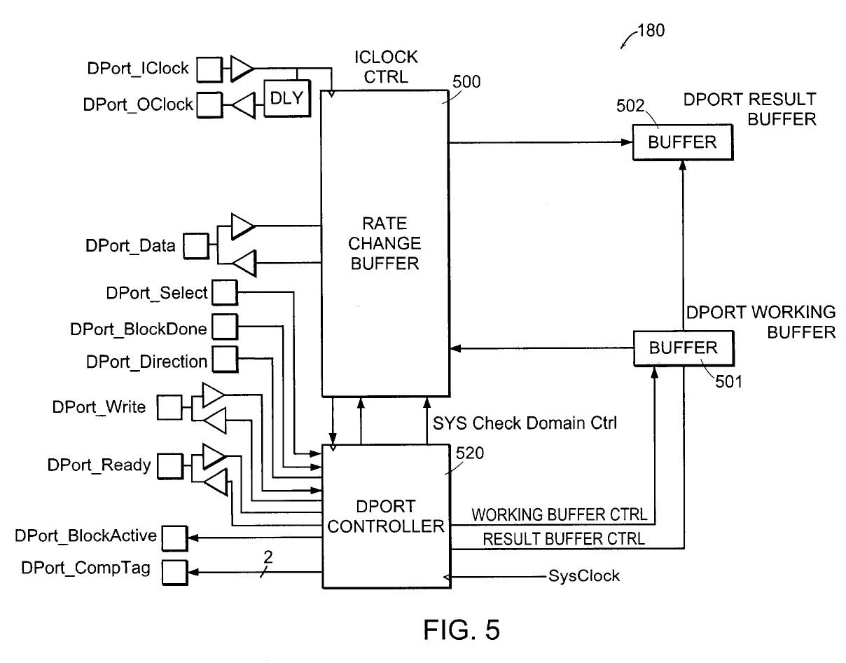

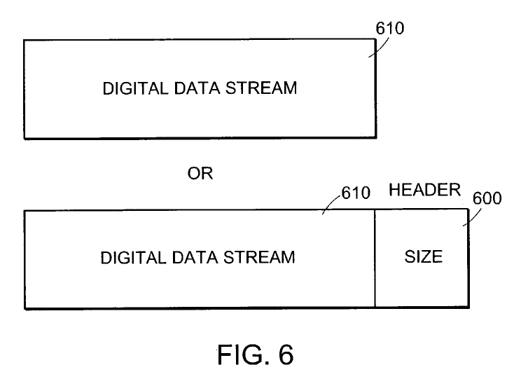

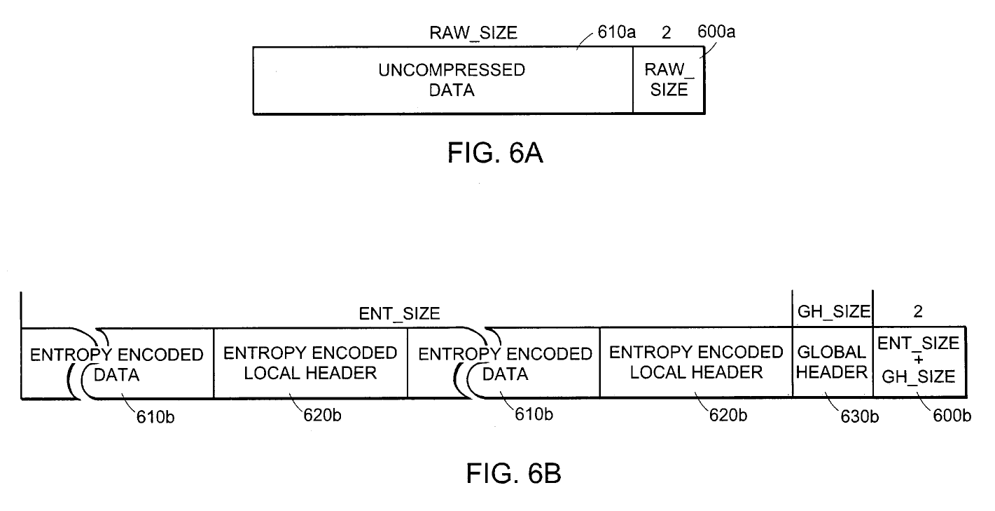

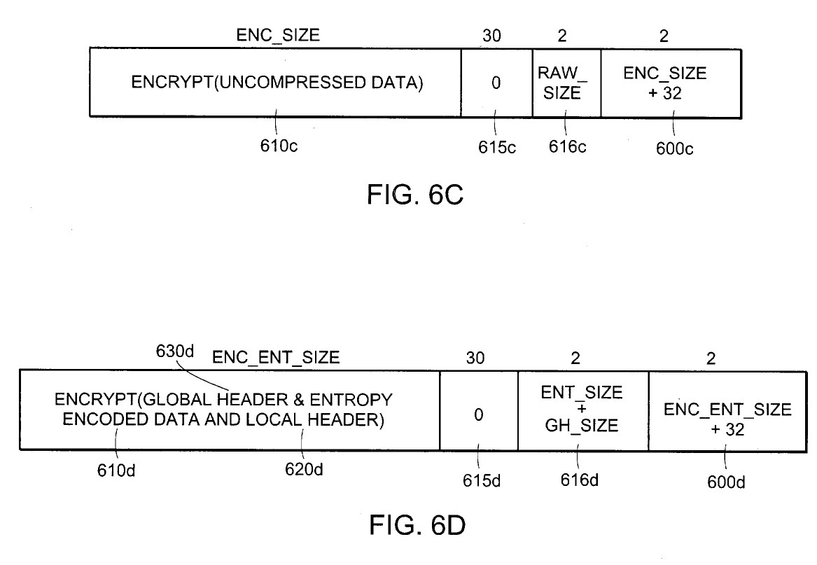

FIG. 6 is a block diagram showing the data format that exits the data I/O port. The data I/O port is the last module through which the digital image stream passes. Prior to entering the data I/O port the digital image stream has been converted to a digital data stream. The data I/O port determines the size from either an attached size header of the digital data stream as it is input into the data I/O port or receives the size through a thread processing language signal. The output of the data I/O port may or may not have a header 600. In embodiments in which a header is present, the header represents the size of the attached data 610. For example, if the data does not undergo either entropy encoding/quantization or encryption the size header 600A simply represents the size of the attached data 610A as shown in FIG. 6A. The size header is fixed in length and in one embodiment may be two data words in length. Since it is a known size and does not vary, no block boundary is necessary. If the digital image stream passes through the entropy encoder and quantizer, then the size header represents 600B the size of the entropy encoded data 610B, the size of the entropy encoded local header 620B and the global header 630B as shown in FIG. 6B. If the digital image stream is only encrypted in the crypto module the size header 600C at the output of the data I/O port includes the encrypted digital image data 610C plus the block boundary 615C plus the encryption module size header 616C as shown in FIG. 6C. Similarly, if the digital data stream passes through both the entropy encoder module and also the encryption module then the size header 600t) for the data I/O port accounts for the encrypted entropy encoded data 610D along with the local 620D and global headers 630D along with the block boundary 615D and the size header 616D from the encryption module as shown in FIG. 6D.

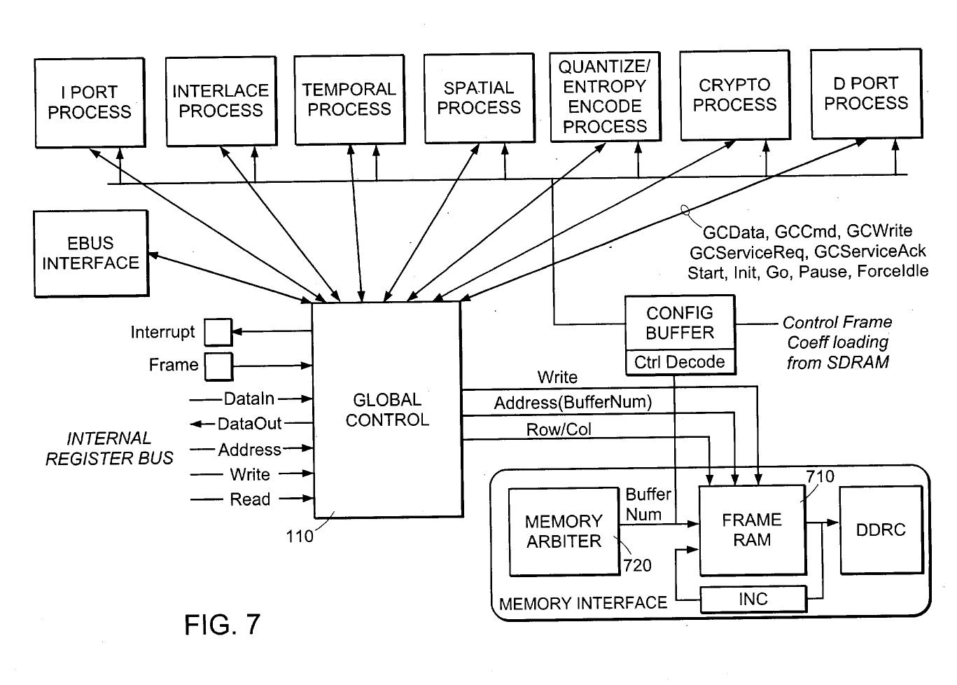

FIG. 7 is a block diagram of the global control module 110 interacting with each of the seven processing modules along with the electronic bus that couples all of the modules and the frame memory for sending data to external memory. The global control module 110 sequences and synchronizes the module processes within the electronic circuit. Each individual module controls its own internal sequencing over a task whereas the global control module coordinates inter-task synchronization. Upon initialization of the electronic circuit, the external CPU access from memory a program which contains code understood by each of the modules. Each of the modules receives its own code sequence. The coding language may be any coding language, such as, thread processing language, as is known by one of ordinary skill in the art. Each module then runs independently, but is programmed to interact with the flag register of the global control module. Each module looks for a trigger bit or trigger sequence within the flag registers of the global control module. The flag register has multiple flag bits which can be read and written to by the individual modules. Each module can scan the registers looking for a trigger sequence. If that sequence is written in the flag registers, the module will execute its internal process. For example, the temporal transform module loads its trigger monitor with a bit pattern it expects the spatial module to mark when the spatial module is finished processing. When the trigger monitor of the temporal module senses the bit pattern in the flag registers, the temporal module can begin its internal processing of the digital image stream. Access by a module to the registers for writing is arbitrated by the global control module 110. The global control module acknowledges a request for writing to the registers and grants the request by issuing a release command. When the requesting module is finished wring access is given back to the global control module by issuing a release command.

In addition to serving as an inter-process communications resource, the global control module, also loads the frame memory 710 that maps the data to external memory from the communication bus.

Each module is provided with its own buffer for importing data from the communication's bus and for exporting data to the communication's bus. A memory bus arbiter 720 allocates memory bandwidth to each buffer according to its priority as designated by the global control module. The working buffers of a module only send read requests to the memory arbiter and the result buffers of a module only send write requests to the memory arbiter.

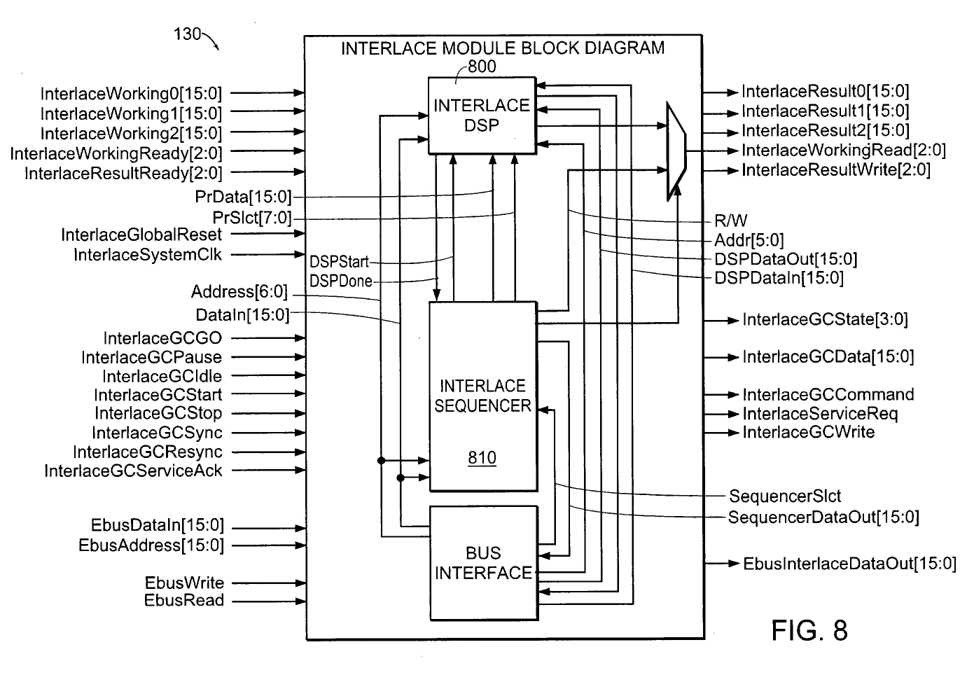

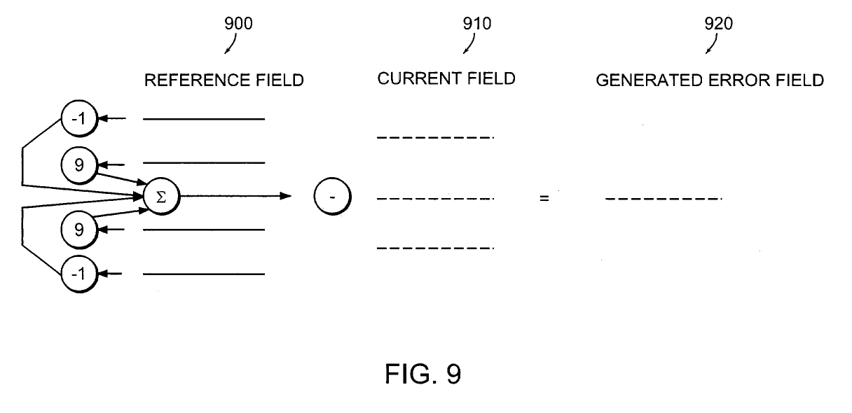

The interlace processor is shown in FIG. 8. The interlace module 130 is composed of an interlace digital signal processing module 800 and an interlace sequencer module 810. In one embodiment, the interlace digital signal processing module 800 performs field filtering using data from a reference field and a current field to compute an error field. The reference field is one of the two fields in a frame of digital video. Data from the reference field is processed by a binomial half hand filter to generate a predicted field. The prediction field is a determination of what the image data corresponding to the current field of the video frame pair would be if there were a substantial lack of motion between the reference field and the current field. The current field is subtracted from the predicted field to generate a high frequency error field. This process is shown in FIG. 9. FIG. 9 shows the reference field 900 being transformed such that the line numbers match with the current field 910 after having undergone the transform to create the predicted field 900. The predicted field 900 is then subtracted from the current field 910 as shown to obtain the error field 920. Since the prediction field, 900 corresponds to a current field that is assumed to have no motion, the error field substantially correlates to the motion between frames. The predicted image data can then be processed as if the digital image data was progressive data.

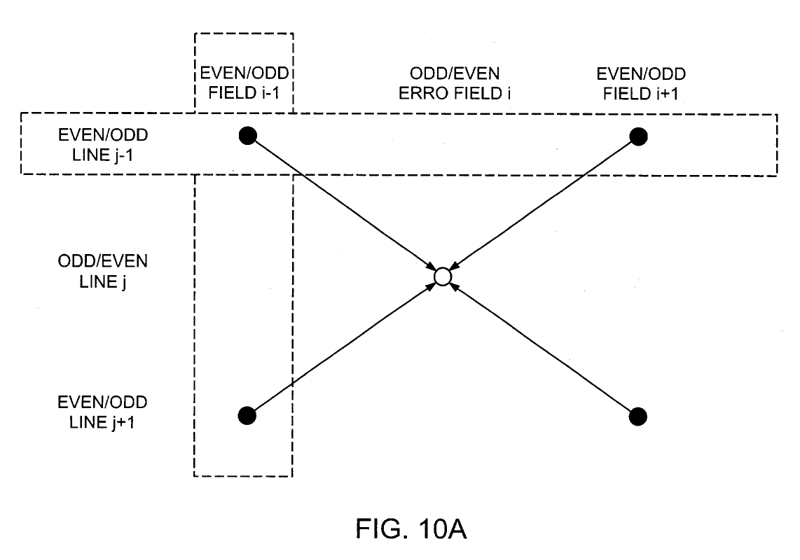

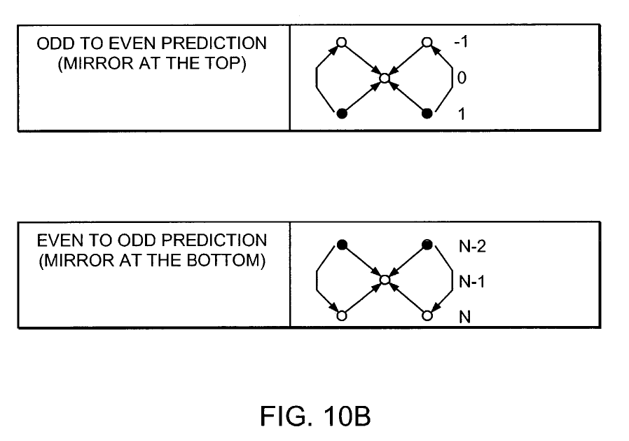

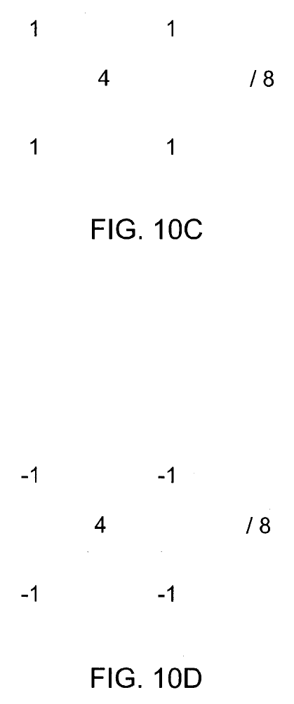

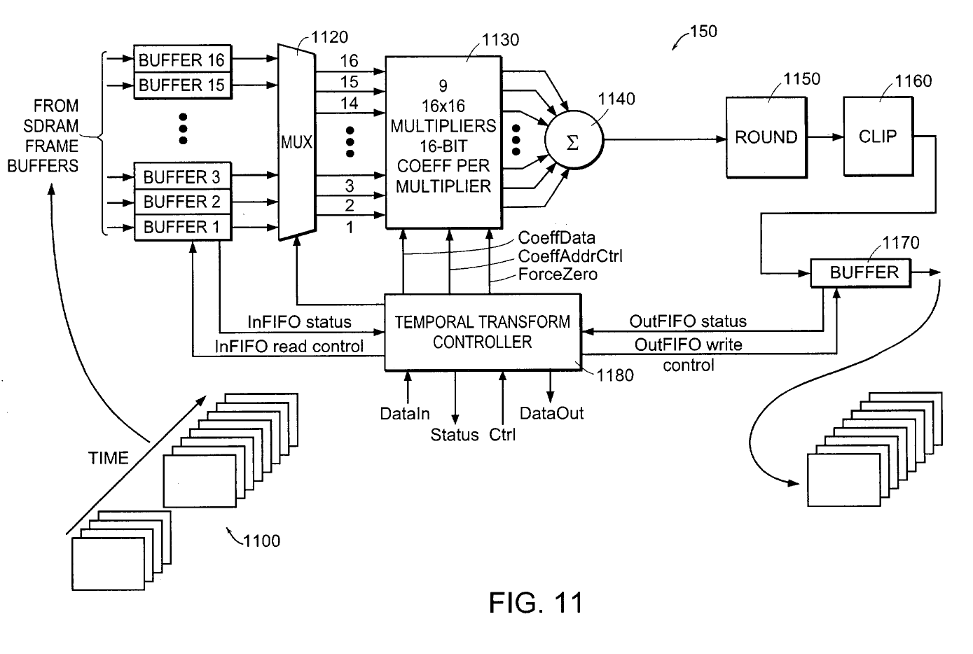

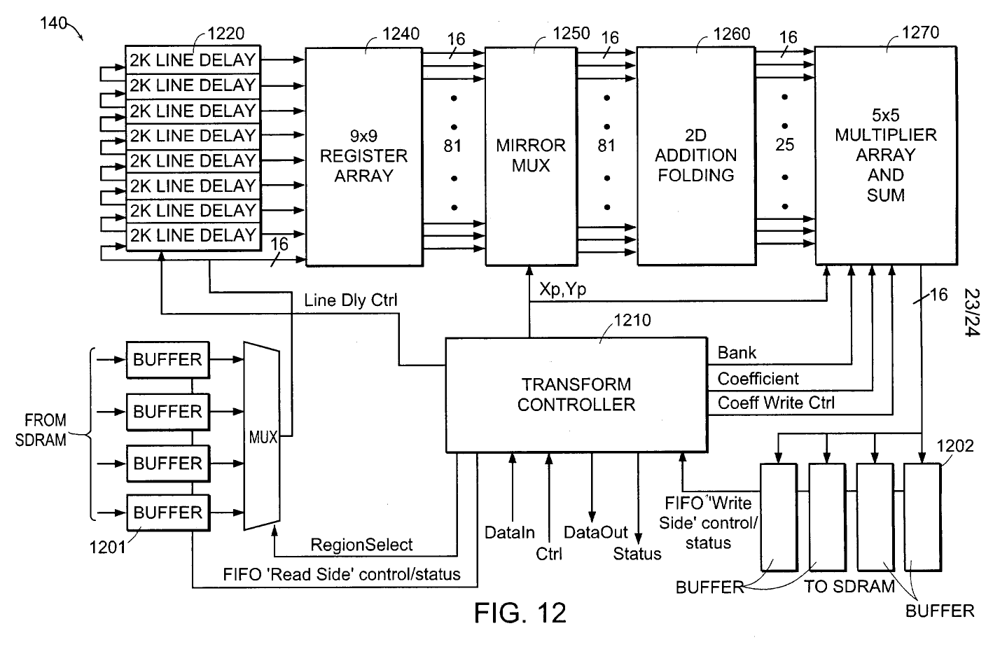

In an alternative embodiment, a wavelet transform is used to decorrelate the two interlaced fields. The wavelet transform is at least a two dimensional transform over horizontal distance and time. The wavelet transform separates the image into high and low frequency components, thus decorrelating for both space and time. To implement this transform, a filter is passed over a neighboring field of data, such that a field before the current field in the digital image stream or a field after the digital image stream is buffered for processing the current frame of the digital image stream. In this process data points are interpolated between the neighboring fields. For example, if the current pixel value is at line 3 pixel 7, near neighbor pixels in the immediately preceding fields or subsequent field that are in lines 2 and 4 and are used for the interpolation. A generalization of this interpolation is shown in FIG. 10A. When the top and bottom lines are processed, mirroring of the data is used to provide for valid filtering of the current value. The video values from the preceding and subsequent fields will be repeated. For example, if the top line (line 1) is being processed in an odd field the second line from an even numbered field will be mirrored. For example see FIG. 10B for the mirroring scheme. FIG. 10C shows one example of the filter which is a 3-by3 dimensional filter. In this embodiment, the two-dimensional filter is biorthogonal and implements a vertical transform. In one embodiment the filter is applied to each across a component value such that the 4 is centered on the center element that is being transformed. The elements above and below are in the lines of the field that is either preceding or subsequent to the current field. The filter values are multiplied by the respective values in the appropriate filed and then added together and divided by eight. Using this transform a high frequency component is determined. A low frequency component can be determined applying the filter shown in FIG. 10D. To recover the original data the inverse transforms are applied. It should be understood by one of ordinary skill in the art that the filter that occurs as a result of the wavelet transform need not be a 3-by-3 two dimensional transform and could be of a higher dimension.

The temporal transform module 150 includes a 9 tap FIR filter that operates on time-aligned samples across a sliding window of nine temporal image frames. The temporal transform module 150 processes multiple frames at a time produces multiple output frames. This provides conservation in memory bandwidth. The implementation requires 16 input frames 1100, but decreases memory bandwidth. 16 memory buffers feed a multiplexer 1120 that routes the frames to one of nine multipliers 1130 of the filter as shown in FIG. 11. Each multiplier 1130 has local 16-bit coefficients in one embodiment. The output of the multipliers 1130 are summed in summer 1140. The values are scaled, rounded in rounder 1150 and clipped in clipping module II 60. The output of the clipping module is routed to a memory output buffer 1170 that produces eight output frames from the 16 input frames. The rounding and clipping operation in the round module 1150 and the clipping module 1160 are performed to transform the values to an appropriate bit size, such as 16-bit, two's compliment value range. The temporal transform controller 1180, provides the coefficient values for the filter, as well as the addresses of the coefficients within the 9tap filter. At the beginning of the digital image stream and at the end of the digital image stream, the temporal transform module mirror image frames around the center tap of the filter. The mirroring is controlled by the temporal transform controller 1180. Input frames are mirrored by pointing two symmetrically located frame buffers to the same frame.

The spatial transform module 140 is designed around a two dimensional convolution engine. In the embodiment shown in FIG. 12 the convolver is a 9×9: 2D matrix filter. In this embodiment the convolver possesses both horizontal and vertical symmetry such that only a 5×5 matrix of multipliers are necessary. The symmetry is such that 16 taps fold 4 times, 8 taps fold 2 times and the center tap has no folding. The spatial transform may be invoked recursively within the spatial transform module through the transform controller.

The spatial transform module 140 has four working buffers 1201 and four result buffers 1202. Data from the working buffers 1201 is selected via the transform controller 1210 and passed to eight 2 k deep line delays 1220. The eight 2K line delays 1220 along with the 9^{th} input line from memory 1230 are used to buffer the data going to the convolver. The outputs of the line delays are connected to the convolver and to the input of the next line delay so that the lines advance vertically to effectively advance the position of the convolver within the image. These line delays coupled with the register array 1240 present the convolver with an orthogonal data window that slides across the input data set. Boundary conditions exist whereby some of the convolver's inputs do not reside over the top of the image or the region locations do not contain valid data. In the cases where the convolver does not completely overlay valid data, the missing data points are created by mirroring data about the horizontal and vertical axis of the convolver as necessary. For example, at the upper left corner of the image, the center tap along with the lower right quadrant of the convolver overlays valid data while the other three quadrants lack valid data. In such as situation, the transform controller 1210 causes the mirroring multiplexer 1250 to mirror the data from the lower right quadrant into the other three quadrants for processing. As the convolver processes the image stream data for an image the convolver goes through 81 uniques modes. Each of these modes requires a slightly different mirroring. The mirroring multiplexer 1250 supports mirroring of valid data over convolver taps that are outside the range of valid data. The transform controller 1210 utilizes the received destination instructions from the external central processing unit and controls the writing of the resultant data to the result buffers 1202.

It should be understood by one of ordinary skill in the art that the convolver changes coefficients on a per cycle basis. Each multiplier in the convolver has multiple local coefficient registers. The transform controller 1210 keeps track of the (x,y) position of the convolver within the image. Based on the 9×9 size of the convolver, the center tap can be over a valid output location even though 4 vertical or horizontal tap are over invalid data. These +4 to −4 situation are shown in FIG. 13. For example, there may be four registers such that a coefficient can be selected dependent on the horizontal and vertical phase (odd or even). In addition to the four local coefficients, alternative sets of coefficients are stored in coefficient frames within external memory. A given set of coefficients is transferred to the local coefficient registers under the control of a spatial transform sequencer (not shown).

Thus, once the data is properly determined by the mirror multiplexor 1250, it is passed to the 2D addition folding module 1260. The 2D addition folding module transmits the data points to the 5×5 multiplier 1270 for performing the convolution. The 2D addition folding module 1260 selects the appropriate values for the folded convolution process such that only 25 values are processed at a time for the 81 values.

It should be understood by one of ordinary skill in the art, that each module has been described with respect to the encoding process, but that each module could be programmed through program code to decode a digital data stream back into a digital image stream.

Further, it should be understood that the resultant digital data stream may be output and stored on a medium, such as a CD-ROM or DVD-ROM for later decompression using the above described ASIC for decoding or decompressed in a software version of the ASIC that operates in a decoding mode.

In an alternative embodiment, part of the disclosed invention may be implemented as a computer program product for use with the electronic circuit and a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Further the digital data stream may be stored and maintained on a computer readable medium and the digital data stream may be transmitted and maintained on a carrier wave.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. An electronic chip for processing a digital image stream having digital data values representing a pixels, the electronic chip comprising:
a compression module for compressing the digital image stream so that upon decompression the digital image stream maintains a pre-determined signal to noise ratio for each digital data value.

2. An electronic chip for processing a digital image stream having digital data values, the electronic chip comprising:
a compression module for compressing the digital image stream wherein digital data values are quantized so as to maintain a desired resolution over all frequencies.

3. The electronic chip according to claim 1 further comprising:
a digital image input port for receiving the digital image stream.

4. The electronic chip according to claim 1 further comprising:
a digital data output port for outputting the digital data stream formatted as a digital data packet.

5. The electronic chip according to claim 1, further comprising:
an interlaced module for converting a digital image stream from an interlaced format to a progressive format.

6. The electronic chip according to claim 1, further comprising:
an interlace module for decorrelating both spatially and temporally each pair of fields representing a frame.

7. The electronic chip according to claim 1, further comprising an encryption module for encrypting the digital image stream.

8. The electronic chip according to claim 1, wherein the compression module is configured to perform wavelet-based transforms.

9. The electronic chip according to claim 1, wherein the compression module includes
a spatial transform module wherein the spatial transform module is capable of employing a wavelet transform to decorrelate each image within the digital image stream into a plurality of frequency bands.

10. The electronic chip according to claim 1, wherein the compression module includes:
a temporal transform module capable performing a temporal decorrelation using a wavelet transform on the digital image stream to transform the digital image stream into a plurality of frequency bands.

11. The electronic chip according to claim 9, wherein the compression module includes:
a quantization module for assigning a quantization level to each defined frequency bard according to sampling theory.

12. The electronic chip according to claim 9, wherein the quantization module includes
circuitry for quantizing each transformed digital data value so that each transformed digital data value has the proper resolution for maintaining a desired quality level over all digital data values in the digital image stream.

13. The electronic chip according to claim 12, further comprising an entropy encoder.

14. The-electronic chip according to claim 13, wherein the entropy encoder includes circuitry for selecting a probability distribution function based upon a characteristic of the digital image stream.

15. The electronic chip according to claim 12, wherein the quantization module includes circuitry for assigning quantization levels with greater accuracy to each frequency band of lower frequency.

16. The electronic chip according to claim 3, wherein the digital data output port has circuitry for adding a header to the digital data packet, wherein the header at least indicates size.

17. The electronic chip according to claim 16, wherein the size header indicates the size of the original digital image stream.

18. The electronic chip according to claim 1, wherein the compression module performs compression of the digital image stream in real-time.

19. The electronic chip according to claim 1, wherein the digital image stream is streaming media.

20. The electronic chip according to claim 3, wherein the digital data packet contains an encrypted data from the digital image stream.

21. The electronic chip according to claim 3, wherein the digital data output port adds a block boundary aligner to the header.

22. The electronic chip according to claim 3, wherein the digital data output produces a digital data packet that contains an entropy encoded data packet with a header field and a size field.

23. The electronic chip according to claim 22, wherein the header field may contain entropy parameters.

24. The electronic chip according to claim 23, wherein the entropy parameters may include signal to noise ratio, core magnitude, dither magnitude and dither seed.

25. Digital data on a carrier wave, the digital data comprising: compressed digital data that upon decompression maintains at least a predetermined signal to noise ratio over all digital data values.

26. The digital data according to claim 25, wherein the digital data further includes an appended header.

27. The digital data according to claim 26, wherein the header indicates the size of the digital data that is compressed.

28. The digital data according to claim 26, wherein the header indicates the size of the digital data prior to being compressed.

29. The digital data according to claim 25, wherein the compressed digital data is encrypted.

30. The digital data according to claim 25 wherein the digital data upon decompression includes a header which indicates the pre-determined quality level.

31. An electronic chip for processing digital video, the system comprising:
a digital image input for receiving a digital image stream;
a wavelet-based compression module capable of compressing the digital image stream maintaining a predetermined quality level over all frequencies within the digital image stream;
a digital data output for outputing a digital data stream having the format of a digital data packet.

32. The electronic chip according to claim 31, further comprising:
an interlaced-module for converting a digital image stream from an interlaced format to a progressive format.

33. The electronic chip according to claim 32, wherein the interlaced processor decorrelates each pair of fields representing a frame both spatially and temporally.

34. The electronic chip according to claim 31, further comprising an encryption module for encrypting the digital image stream.

35. The electronic chip according to claim 31, wherein the wavelet-based compression module includes:
a spatial transform module wherein the spatial transform module is capable of employing a wavelet transform to decorrelate each frame of video within the digital image stream into a plurality of frequency bands.

36. The electronic chip according to claim 35, wherein the wavelet-based compression module includes:
a temporal transform module capable performing a temporal decorrelation using a wavelet transform on the digital image stream to transform the digital image stream into a plurality of frequency bands.

37. The electronic chip according to claim 36, further comprising:
a quantization module for assigning a quantization level to each defined frequency band.

38. The electronic chip according to claim 37, further comprising an entropy encoder.

39. The electronic chip according to claim 37, wherein the quantization module assigns quantization levels with greater accuracy to each frequency band of a lower octave.

40. A digital data packet on a carrier wave, the digital data packet comprising:
digital data that is compressed using a wavelet based transform maintaining a pre-determined quality level over all frequencies of the digital data.

41. An electronic chip for processing a digital image stream having digital data values representing a pixels, the electronic chip comprising:
means for compressing the digital image stream so that upon decompression the digital image stream maintains a pre-determined signal to noise ratio for each digital data value.

42. An electronic chip for processing a digital image stream having digital data values, the electronic chip comprising:
means for compressing the digital image stream wherein digital data values are quantized so as to maintain a desired resolution over all frequencies.

43. The electronic chip according to claim 41 further comprising:
means for receiving the digital image stream.

44. The electronic chip according to claim 41 further comprising:
means for outputting the digital data stream formatted as a digital data packet.

45. The electronic chip according to claim 41, further comprising:
means for converting a digital image stream from an interlaced format to a progressive format.

46. The electronic chip according to claim 41, further comprising:
means for decorrelating both spatially and temporally each pair of fields representing a frame.

47. The electronic chip according to claim 41, further comprising an means for encrypting the digital image stream.

48. The electronic chip according to claim 41, wherein the means for compressing is configured to perform wavelet-based transforms.

49. The electronic chip according to claim 41, wherein the means for compressing includes
means for employing a wavelet transform to decorrelate each image within the digital image stream into a plurality of frequency bands.

50. The electronic chip according to claim 41, wherein the means for compressing includes:
means for performing a temporal decorrelation using a wavelet transform on the digital image stream to transform the digital image stream into a plurality of frequency bands.

51. The electronic chip according to claim 49, wherein the means for compressing includes:
means for assigning a quantization level to each defined frequency band according to sampling theory.

52. The electronic chip according to claim 49, further comprising:
means for quantizing each transformed digital data value so that each transformed digital data value has the proper resolution for maintaining a desired quality level over all digital data values in the digital image stream.

53. The electronic chip according to claim 52, further comprising means for entropy encoding.

54. The electronic chip according to claim 44, wherein the means for outputting includes means for adding a header to the digital data packet, wherein the header at least indicates size.

55. The electronic chip according to claim 16, wherein the size header indicates the size of the original digital image stream.

56. A digital data sequence on a processor-readable medium, the digital data sequence on the processor-readable medium comprising:
compressed digital data that upon decompression maintains at least a pre-determined signal to noise ratio over all digital data values.

57. The digital data sequence on a processor readable medium according to claim 46, wherein the digital data further includes an appended header.

58. The digital data sequence on a processor readable medium according to claim 57, wherein the header indicates the size of the digital data that is compressed.

59. The digital data sequence on a processor readable medium according to claim 57, wherein the header indicates the size of the digital data prior to being compressed.

60. The digital data sequence on a processor readable medium according to claim 56, wherein the compressed digital data is encrypted.

61. The digital data sequence on a processor readable medium according to claim 56 wherein the digital data upon decompression includes a header which indicates the predetermined quality level.
